(19) United States
(12) Patent Application Publication
(10) Pub. No.: US 2016/0277721 A1
(43) Pub. Date: Sep. 22, 2016

(54) COLOR FILTERED AREA PROCESSING METHOD FOR IMPROVING IMAGE PROCESSING

(71) Applicant: STMicroelectronics (Grenoble 2) SAS, Grenoble (FR)

(72) Inventor: Gregory Roffet, Coublevie (FR)

(73) Assignee: STMICROELECTRONICS (GRENOBLE 2) SAS, Grenoble (FR)

(21) Appl. No.: 14/660,646

(22) Filed: Mar. 17, 2015

(51) Int. Cl. H04N 9/64; H04N 9/77; H04N 9/07

(52) U.S. Cl. CPC H04N 9/646; H04N 9/07; H04N 9/77

(57) ABSTRACT

An electronic device includes an image sensor configured to acquire raw image data in a color filtered array format. A processor is coupled to the image sensor and configured to demosaic the raw image data in the color filtered array format into RGB image data having red data, green data, and blue data. The processor also performs color noise reduction on the red data, green data, and blue data of the RGB image data so as to produce corrected image data. The processor further converts the corrected image data into corrected image data in the color filtered array format.

### BACKGROUND

Digital photography is popular and widespread in the world today. In addition to the numerous models and types of standalone digital cameras for sale on the consumer market, most cellular telephones and tablets have a digital camera integrated therein. In fact, digital photography is so popular that smart-watches that include a digital camera integrated therein are even on the market.

With the popularity of digital photography, there is a consumer desire and thus a commercial need for digital cameras, both standalone and incorporated into other electronic devices, that take sharp, high quality pictures that are pleasing to the consumer. That equates to a commercial need for advanced image processing techniques capable of delivering those sharp, high quality pictures even when the conditions under which said pictures are taken are not ideal.

The small size of image sensors and lenses used in cameras for smartphones, tablets, and smart-watches may result in misinterpretation of pixel data during image capture, ultimately leading to erroneous color reproduction and a lack of clarity in portions of an image where dark colored areas border light colored areas. Therefore, image processing techniques that correct this color reproduction and lack of clarity are desired.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

One aspect is directed to an electronic device including an image sensor configured to acquire raw image data in a color filtered array format. A processor is coupled to the image sensor and configured to demosaic the raw image data in the color filtered array format into RGB image data having red data, green data, and blue data. The processor also performs color noise reduction so as to produce corrected enhance colorized image data. The processor further converts back the corrected enhance colorized data into corrected image data in the color filtered array format.

The color filter array format may be a bayer mosaic.

The image sensor may be an array of photo-sensors having a color filter array applied therein, and the color filter array comprises a bayer filter mosaic.

Another aspect is directed to an electronic device including an image sensor configured to acquire raw image data in a color filtered array format, and a processor coupled to the image sensor. The processor is configured to demosaic the raw image data in the color filtered array format into RGB image data having chrominance data and luminance data, and perform color noise reduction on the chrominance data so as to produce corrected formatted image data. The processor also converts back the corrected colorized image data into corrected image data in the color filtered array format.

Another aspect is directed to an electronic device including an image sensor configured to acquire raw image data in a color filtered array format, and a processor coupled to the image sensor. The processor is configured to demosaic the raw image data in the color filtered array format into YUV image data having chrominance data and luminance data, and perform color noise reduction on the chrominance data so as to produce corrected formatted image data. The processor is also configured to convert the corrected colorized image data back into corrected image data in the color filtered array format.

A method aspect is directed to a method including performing an operation to demosaic raw image data into color space data having chrominance data and luminance data, using a processor. Color noise reduction is performed on the chrominance data based, possibly using luminance information, on so as to produce corrected colorized image data, using the processor. The corrected formatted image data is then converted back into corrected image data in the filtered format, using the processor.

Another aspect is directed to an electronic device which is called an image processor. This image processor can be external to the image sensor and configured to acquire raw image data in a color filtered array format, or internal to image sensor and configured to acquire raw image data in a color filtered array format.

### BRIEF DESCRIPTION OF THE DRAWINGS

FIG. 1 is a block diagram of an electronic device on which the image processing techniques described herein may be performed.

FIG. 2 is a schematic block diagram of the image sensor of FIG. 1.

FIG. 3A is process diagram of an image processing method in accordance with this disclosure that may be performed on the electronic device of FIG. 1.

FIG. 3B is process diagram of an image processing method in accordance with this disclosure that may be performed on the electronic device of FIG. 1.

FIG. 4 is a detailed flowchart of an image processing method in accordance with this disclosure that may be performed on the electronic device of FIG. 1.

FIG. 5A is an image wherein color noise reduction has been performed on chrominance data and luminance data. This luminance is computed using only one demosaiced channel, which in this case is the green channel.

FIG. 5B is an image wherein color noise reduction has been performed using a complete demosaic of the color filter array data to estimate the luminance component as well as chrominance components of image data, using the image processing techniques described herein.

FIG. 6A is an image wherein color noise reduction has been performed on chrominance data and luminance data. This luminance is computed using only one demosaiced channel, which in this case is the green channel.

FIG. 6B is an image wherein color noise reduction has been performed using a complete demosaic of the color filter array data to estimate the luminance component as well as chrominance components of image data, using the image processing techniques described herein.

### DETAILED DESCRIPTION

One or more embodiments will be described below. These described embodiments are only examples of implementation techniques, as defined solely by the attached claims. Additionally, in an effort to provide a focused description, irrelevant features of an actual implementation may not be described in the specification.

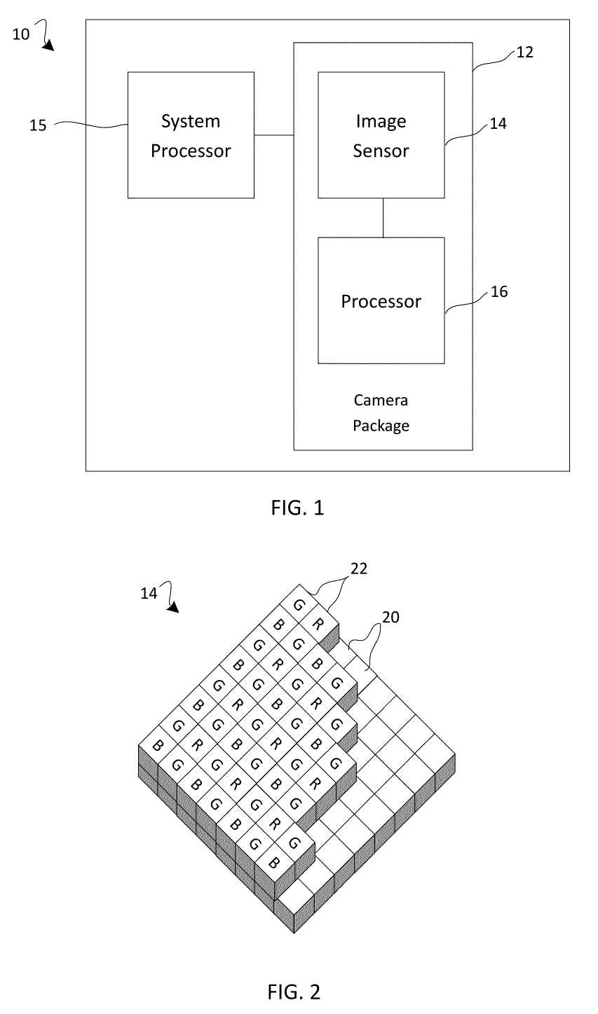

Image processing techniques will be described herein, however first an electronic device 10 which can be used to perform such image processing techniques will now be described with reference to FIG. 1. The electronic device 10 can be a consumer product, such as a smartphone, tablet, point and shoot digital camera, or SLR digital camera. The electronic device 10 includes a system processor 15 or system-on-chip used for executing applications such as operating systems, camera software, and social media applications. The electronic device 10 also includes an image sensing package 12 having an image sensor 14 for capturing image data, and a processor 16 for applying the image processing techniques to the image data. It should be understood that the prior art sensing packages 12 provide raw image data which is then processed by the system processor 15. The image processing techniques described herein are instead to be performed by the processor 16 in the sensing package 12, and not by the system processor 16 of the electronic device 10. The system processor 15 may perform additional image processing on the image data using different techniques.

Details of the image sensor 14 will now be described with further reference to FIG. 2. The image sensor 14 includes an array of photo-sensors 20. The photo-sensors 20 are illustratively in a square array, although any shape array may be used. The photo-sensors 20 can be CCD photo-sensors, CMOS photo-sensors, or any other suitable type of photo-sensor. As example, a Bayer color filter array 22 (also referred to as a mosaic) is applied on the array of photo-sensors 20, and serves to limit the colors that each photo-sensor 20 can detect to the spectrum of a single color. The Bayer color filter array 22 contains a ratio of 50% green filters to 25% red filters and 25% blue filters, and may be referred to as a RGBG, GRGB, or RGGB color filter array. Thus, each pixel is filtered to record only red, green, or blue.

Since each pixel of the raw (unaltered) image captured by the photo-sensors 20 through the Bayer color filter array 22 is limited to one of three colors, the data from each pixel does not include values of the other colors, and the raw image if displayed would not be a full-color image. This raw image data can be referred to as raw Bayer image data.

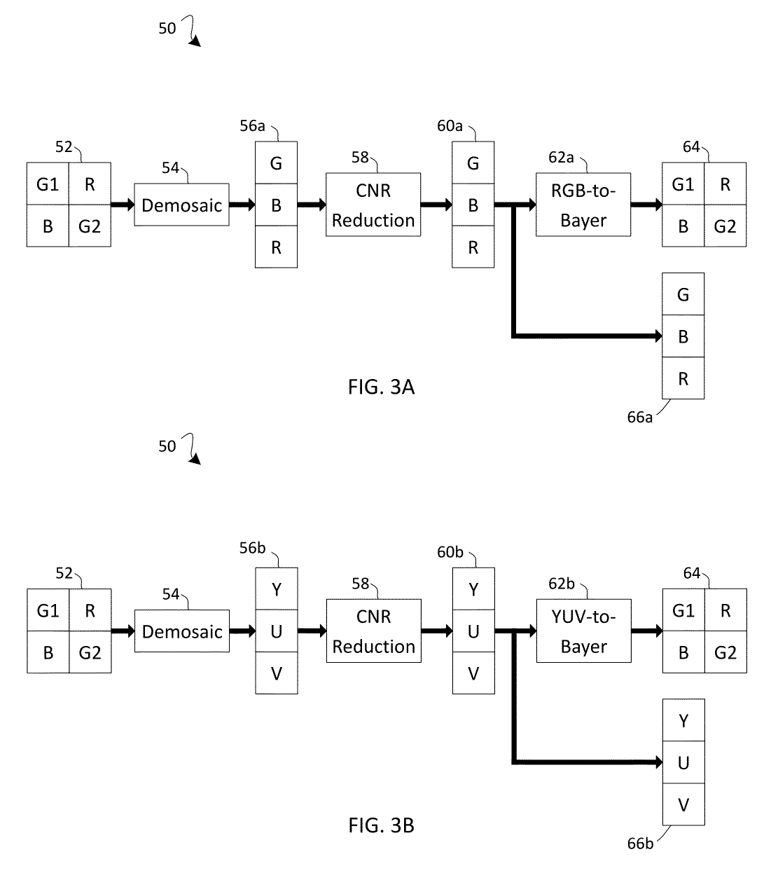

Referring to the process diagrams 50 of FIGS. 3A and 3B, acquired raw image data 52 is demosaiced 54 into RGB image data 56A or YUV image data 56B. The demosaicing can be performed by a variety of algorithms known to those of skill in the art. These algorithms serve to, for each pixel, interpolate the two color values that are missing based upon the surrounding pixels of those color values. As an example of one interpolation algorithm, when demosaicing to RGB format, the algorithm may interpolate a green and blue value for each red pixel, based upon green and blue pixels, respectively, surrounding that red pixel.

A demosaic is used to recover the full resolution on each color filter array channel. This demosaic can be a bilinear demosaic based on the closest neighbors, or a more complex demosaic like a directional demosaic or a frequencies demosaic. This demosaic is a way interpolate the missing color filter data at each color filter array position.

If the image data is in RGB format, the RGB image data can be transformed in a luminance component and a chrominance component. The luminance represents the brightness of a pixel, while the chrominance represents the color of a pixel. This color space conversion can be a RGB to YUV conversion as example.

Image data with sharp transitions between colors and/or brightness levels may often lead to color noise or more precisely aliasing and other errors which degrade the accuracy and sharpness of the resulting image. This color noise or other errors are due to imperfections or limitations in the image sensor 14 technology when the light conditions become difficult. We are used to consider the LUX level of an image. Lower this LUX is, higher the color noise of such system will be important and annoying. Therefore, after demosaicing, color noise reduction 58 is performed on the chrominance components so as to remove or lessen color noise and thereby produce corrected colorized image data 60A or 60B, such as RGB image data or YUV image data. In other words, the color noise reduction 58 is performed on a composition of the red, green, and blue components of the RGB image data which represent the chrominance, or on the chrominance components of the YUV image data. This produces corrected RGB or YUV image data 60A or 60B, which can then be converted back into color filter array (i.e.: Bayer) format 62A or 62B and output as color filter array (i.e.: Bayer) data 64, or output directly in RGB format 66A or YUV format 66B. Neither the input color filter nor the output color filter is limited to color filter array (i.e.: Bayer), and indeed other color filtered may be used.

By performing a complete demosaic to pass the image data from the color filter array format to a colorized format, any standard color processing algorithms of a reconstruction image processing chain may be used. Indeed, this extends the color noise reduction performed on the colorized format to be able to be done use any processing algorithm that works on colorized information. These algorithms can be a color matrix algorithm, and/or a gamma correction algorithm, and/or color noise reduction, and/or Luma noise correction, and/or sharpening.

The image processing methods herein advantageously perform color noise reduction by using all demosaiced components of an image to estimate the chrominance components, as opposed to prior techniques that typically perform the color noise reduction using but one full reconstructed component, considered as the luminance component, to estimate the chrominance components. These prior techniques used this one full reconstructed component to inform the other components to be filtered.

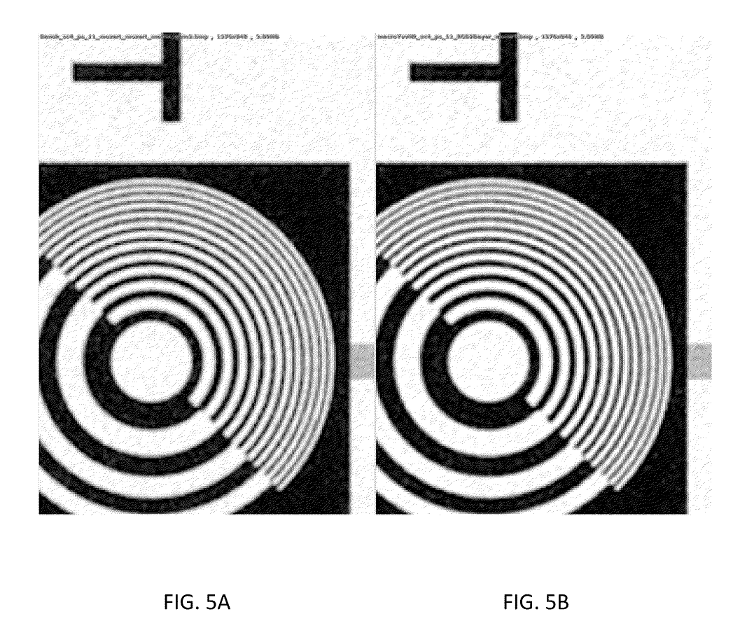

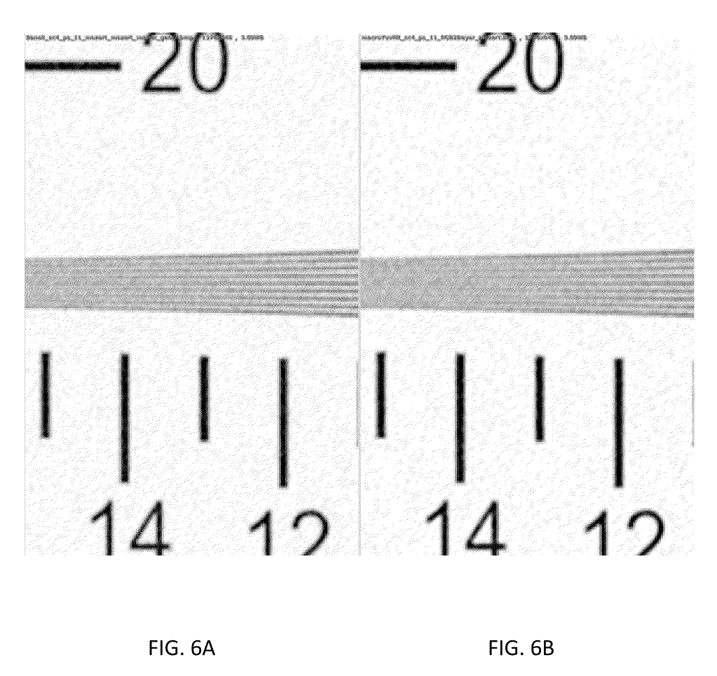

The results of such a prior technique are shown in FIGS. 5A and 6A, in which color noise reduction has been performed on chrominance data and luminance data. This luminance has computed using only the green channel. On the other hand, the results of the techniques described herein are shown in FIGS. 5B and 6B, wherein color noise reduction has been performed on the chrominance data using a complete demosaic of the color filter array data to estimate the luminance component as well as chrominance components of the colorized formatted raw image data.

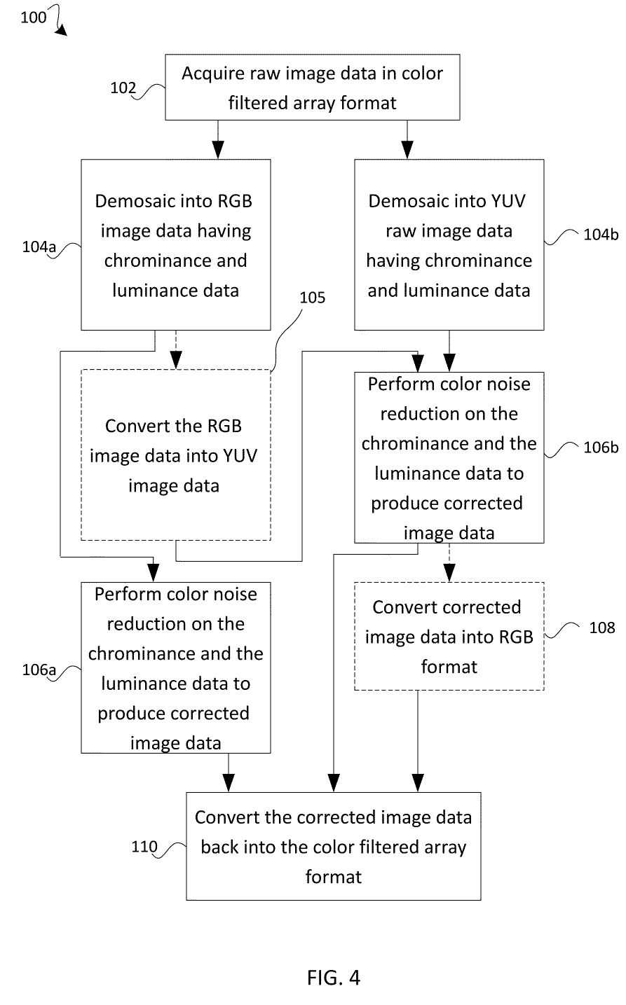

Further details and options for the image processing will now be described. Referring to the flowchart 100 of FIG. 4, raw image data is acquired in a color filtered array format, such as a bayer format (Block 102). Then, the raw image data is demosaiced into either RGB image data (Block 104a) or YUV image data (Block 104b).

In some applications, the RGB image data may then optionally be converted into YUV image data (Block 105). The purpose of proceeding from raw Bayer image data to RGB image data to YUV image data would be to allow the use of a desired demosaic algorithm that is designed to produce RGB image data, yet to then be able to perform subsequent steps using algorithms that operate on YUV data.

In the case where the demosaic is performed to produce RGB image data, color noise reduction is then performed on the chrominance components so as to remove or lessen color noise and thereby produce corrected RGB image data (Block 106a). Similarly, in the case where the demosaic is performed to produce YUV image data, or in the case where the RGB image data is converted to YUV image data, color noise reduction is then performed on the chrominance components so as to produce corrected YUV image data (Block 106b).

In some cases where the corrected formatted image data is in the YUV format, it may be converted back to the RGB format (Block 108). The corrected formatted image data is then converted back into the color filter array format (Block 110). This corrected image data is passed to the system processor 15, which may perform further image processing on the corrected image data.

While the disclosure has been described with respect to a limited number of embodiments, those skilled in the art, having benefit of this disclosure, will appreciate that other embodiments can be envisioned that do not depart from the scope of the disclosure as disclosed herein. Accordingly, the scope of the disclosure shall be limited only by the attached claims.

1. An electronic device, comprising:
an image sensor configured to acquire raw image data in a color filtered array format; and
a processor coupled to the image sensor and configured to:
demosaic the raw image data in the color filtered array format into RGB image data having red data, green data, and blue data,
perform color noise reduction on a composition of the red data, green data, and blue data of the RGB image data so as to produce corrected image data, and
convert the corrected image data back into corrected image data in the color filtered array format.

2. The electronic device of claim 1, wherein the color filter array format comprises a bayer mosaic

3. The electronic device of claim 1, wherein the image sensor comprises an array of photo-sensors having a color filter array applied therein.

4. The electronic device of claim 3, wherein the color filter array comprises a bayer filter mosaic.

5. An electronic device, comprising:
an image sensor configured to acquire raw image data in a color filtered array format; and
a processor coupled to the image sensor and configured to:
demosaic the raw image data in the color filtered array format into RGB image data having chrominance data and luminance data, where the demosaic is performed on the chrominance data and the luminance data;
perform color noise reduction on the chrominance data so as to produce corrected image data, and
convert the corrected image data back into the color filtered array format.

6. The electronic device of claim 5, wherein the color filter array format comprises a bayer mosaic.

7. The electronic device of claim 5, wherein the image sensor comprises an array of photo-sensors having a color filter array applied therein.

8. The electronic device of claim 7, wherein the color filter array comprises a bayer filter mosaic.

9. The electronic device of claim 5, wherein the processor is further configured to convert the RGB image data into YUV image data having chrominance data, prior to performing the color noise reduction.

10. The electronic device of claim 9, wherein the processor produces the corrected image data in YUV format; and wherein the processor converts the corrected image data into corrected image data by converting the corrected image data from the YUV format into corrected image data in RGB format and converting the corrected image data in the RGB format into corrected image data in the color filtered array format.

11. The electronic device of claim 5, wherein the image sensor and processor are integrated into a single package.

12. The electronic device of claim 5, wherein the image sensor and processor are integrated into separate packages.

13. An electronic device, comprising:
an image sensor configured to acquire raw image data in a color filtered array format; and
a processor coupled to the image sensor and configured to:
demosaic the raw image data in the color filtered array format into YUV raw image data having chrominance data and luminance data,
perform color noise reduction on the chrominance data and the luminance data so as to produce corrected image data, and
convert back the corrected image data into corrected image data in the color filtered array format.

14. The electronic device of claim 13, wherein the color filter array format comprises a bayer mosaic.

15. The electronic device of claim 13, wherein the image sensor comprises an array of photo-sensors having a color filter array applied therein.

16. A method, comprising:
performing an operation to demosaic raw image data in a color filter array format into color space image data having chrominance data and luminance data, using a processor, wherein the demosaic is performed on the chrominance data and the luminance data;
performing color noise reduction on the chrominance data so as to produce corrected image data, using the processor; and
converting the corrected image data back into corrected image data in the color filter array format, using the processor.

17. The method of claim 16, wherein the color space image data comprises RGB image data.

18. The method of claim 17, further comprising converting the RGB image data into YUV image data having chrominance data, prior to performing the color noise reduction.

19. The method of claim 16, wherein the color space image data comprises YUV image data.
